(19) United States
(12) Patent Application Publication
(10) Pub. No.: US 2004/0128169 A1
(43) Pub. Date: Jul. 1, 2004

(54) Multiple organization data access monitoring and management system

(76) Inventor: William D. Lusen, East Norriton, PA (US)

Correspondence Address: Alexander J. Burke, Intellectual Property Department 5th Floor, 170 Wood Avenue South, Iselin, NJ, 08830, US

(21) Appl. No.: 10/681,914

(22) Filed: Oct. 9, 2003

Related U.S. Application Data
(60) Provisional application No. 60/419,743, filed on Oct. 18, 2002.

(51) Int. Cl. G06F 7/00; G06F 17/30; G06F 17/60

(52) U.S. Cl. 705/3; 707/3; 707/9

(57) ABSTRACT

A system for monitoring activity of an executable application includes an input processor, an event processor, a monitoring processor, and an output processor. The input processor receives a message identifying an event representing activity performed by an executable application and containing data associated with the event. The event associated data includes a start and stop time of the event. The event processor stores a record of the identified event and the event associated data in a record repository. The monitoring processor selects particular events to use in monitoring a particular activity of the executable application in response to a received command. The output processor collates event-associated data, retrieved from the record repository, for the selected particular events, and processes and formats the collated event data for presentation to a user.

### CROSS-REFERENCE TO RELATED APPLICATIONS

The present application is a non-provisional application of provisional application having serial No. 60/419,743 filed by William David Lusen on Oct. 18, 2002.

### FIELD OF THE INVENTION

The present invention generally relates to information systems. More particularly, the present invention relates to an information system having a multiple organization data access monitoring and management system.

### BACKGROUND OF THE INVENTION

Many industries, organizations, and enterprises (each generally described as enterprises), such as healthcare enterprises, use an electronic information system to organize and optimize their activities. The activities include any function of the enterprise such as accounting, record keeping, word processing, document imaging, scheduling, etc.

Enterprises, such as the healthcare enterprise, have increasing requirements for security, accountability, and productivity. In particular, enterprises having a software system, such as a document imaging system, require users and their supervising management to provide a method to track and report on processing done by document imaging applications in the system responsive to automated processing or a user request. Although a manual paper record of tasks may be used to track user requests, the time for users to generate the manual paper record restricts productivity and does not account for tasks performed by automated processes. In view of the foregoing, it would be preferably desirable to have a central, software-driven mechanism that monitors and records the processed information automatically. Accordingly, there is a need for a multiple organization data access monitoring and management system that overcomes these and other disadvantages of the prior systems.

### SUMMARY OF THE INVENTION

According to one aspect of the present invention, a system for monitoring activity of an executable application includes an input processor, an event processor, a monitoring processor, and an output processor. The input processor receives a message identifying an event representing activity performed by an executable application and containing data associated with the event. The event associated data includes a start and stop time of the event. The event processor stores a record of the identified event and the event associated data in a record repository. The monitoring processor selects particular events to use in monitoring a particular activity of the executable application in response to a received command. The output processor collates event-associated data, retrieved from the record repository, for the selected particular events, and processes and formats the collated event data for presentation to a user.

### BRIEF DESCRIPTION OF THE DRAWINGS

FIG. 1 illustrates a block diagram of an Audit Subsystem of an information system, in accordance with a preferred embodiment of the present invention.

FIG. 2 illustrates a graphic representation of an Event Store, implemented using a relational database, in accordance with a preferred embodiment of the present invention.

FIG. 3 illustrates a user interface window providing job status, in accordance with a preferred embodiment of the present invention.

FIG. 4 illustrates a user interface window providing audit reports, in accordance with a preferred embodiment of the present invention.

FIG. 5 illustrates an audit report directory, in accordance with a preferred embodiment of the present invention.

FIG. 6 illustrates a concurrent usage report, in accordance with a preferred embodiment of the present invention.

FIG. 7 illustrates a user interface window providing audit report types, in accordance with a preferred embodiment of the present invention.

FIG. 8 illustrates a healthcare enterprise having events checked at the enterprise level and at the organization level, in accordance with a preferred embodiment of the present invention.

FIG. 9 illustrates a user interface window providing security functions, in accordance with a preferred embodiment-of-the-present invention.

FIG. 10 illustrates a user interface window providing group selection, in accordance with a preferred embodiment of the present invention.

### DETAILED DESCRIPTION OF THE PREFERRED EMBODIMENTS

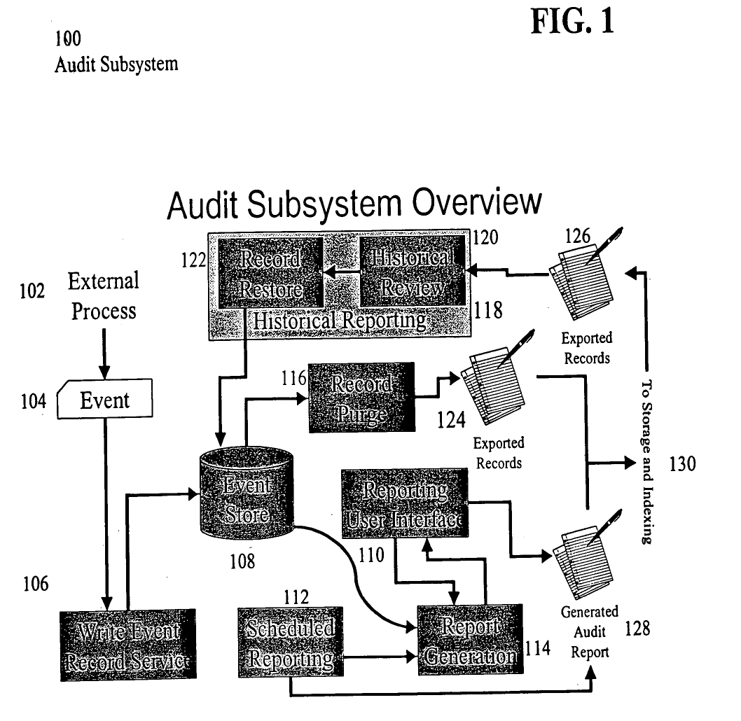

FIG. 1 illustrates a block diagram of an Audit Subsystem 100 of an information system used by an enterprise, in accordance with a preferred embodiment of the present invention. The enterprise includes one or more organization types including, but not limited to, (a) a hospital, (b) a physician group, (c) clinic, (d) a healthcare payer institution, (e) a healthcare provider institution, and (f) a hospital department.

Generally, the Audit Subsystem 100 provides a centralized mechanism to record (generally called “monitor”) and report (generally called “manage”) on activity performed by any software application (otherwise referred as an executable application), whether performed on behalf of a user or an automated process. The Audit Subsystem 100 provides a service that can be called from any software process to keep a record of that processing. The Audit Subsystem 100 also provides a means to report on the processing records it has accumulated.

For the purposes of auditing, activity in an information system includes independent events, each of which is tracked and audited in some way. Preferably, each event is a combination of an action and any data on which that action is performed. Actions may involve, for example and without limitation, reading and/or manipulating data, reading and/or changing system configurations, or simply accessing the system as a whole.

The Audit Subsystem 100 generally includes an External Process 102, and Event 104, a Write Event Record Service 106 (otherwise called an input processor and/or an event processor), and Event Store 108 (otherwise called a record repository), a Reporting User Interface 110 (otherwise called a monitoring processor), a Scheduled Reporting process 112 (otherwise also called a monitoring processor), a Report Generation process 114 (otherwise called an output processor), a Record Purge process 116, a Historical Reporting process 118 having a Historical Review process 120 and a Record Restore process 122, transmitted Exported Records 124, received Exported Records 126, a Audit Report 128, and a Storage And Indexing process 130.

Preferably, the External Process 102 performs a task and records that task as an Event 104 using the Write Event Record Service 106, which stores a record of that event in the Event Store 108. Preferably, the Write Event Record Service 106 provides an input processor for receiving a message identifying an event representing activity performed by an executable application and containing data associated with the event. The event associated data including a start and stop time of said event. Preferably, the Write Event Record Service 106 also provides an event processor for storing a record of the identified event and the event-associated data in the Event Store 108. In a healthcare enterprise, the input processor receives a message identifying an event associated with access by an individual (e.g., user) of one of the organizations to patient medical record information. The patient medical record information includes, without limitation, one or more of: (a) patient clinical information, (b) patient billing or financial information, (c) medical referral information, (d) medical eligibility verification information, (e) medical necessity verification information, and (f) medical procedure cost or reimbursement amount information.

A user may request the generation of audit reports using the Reporting User Interface 110. The user may also use the Reporting User Interface 110 to schedule the generation of the Audit Report 128. The Scheduled Reporting process 112 requests the generation of the Audit Report 128 automatically based on scheduling configuration maintained by the Reporting User Interface 110. Both the Reporting User Interface 110 and the Scheduled Reporting process 112 pass report generation requests to the Report Generation process 114, which queries the Event Store 108 and formats the output into a user-readable report.

Preferably, each of the Reporting User Interface 110 and the Scheduled Reporting process 112 provide a monitoring processor for selecting particular events to use in monitoring a particular activity of the executable application in response to a received command (e.g., automatic or user generated). Preferably, the monitoring processor also selects particular events to use in monitoring a particular activity the executable application in response to received query criteria. Preferably, the monitoring processor also intermittently and automatically selects particular events to use in monitoring a particular activity of the executable application in response to predetermined schedule information. Preferably, the monitoring processor further selects particular events to use in monitoring access to patient medical records in response to received query criteria.

Preferably, the monitoring processor collates records of the selected particular events to provide an audit trail identifying for an individual (e.g., user) of one of the organizations one or more of: (a) a user identifier, (b) an organization associated with the user, (c) a location of the organization associated with the user and (d) a patient record accessed. For a healthcare enterprise, the monitoring processor collates records of the selected particular events to provide an audit trail identifying one or more of: (a) patient record alterations, (b) patient record deletions, (c) patient record additions, and (d) start time and stop time of patient record access. Preferably, patient medical record information includes, without limitation, (a) patient clinical information, (b) patient billing or financial information, (c) medical referral information, (d) medical eligibility verification information, (e) medical necessity verification information, and (f) medical procedure cost or reimbursement amount information.

Preferably, the Report Generation process 114 in combination with the Reporting User Interface 110 provides an output processor for collating event associated data, retrieved from the Event Store 108, for the selected particular events and for processing and formatting said collated event data for presentation to a user. Preferably, the output processor also processes and formats the collated event data for presentation to a user in one or more of: (a) a displayed image, and (b) a report, in response to predetermined schedule information.

The Record Purge process 116 limits the amount of storage required for the Event Store 108 by extracting event records based on their age and archiving any records needed for future reference. The Historical Reporting process 118 makes archived event records available for viewing or active reporting by either displaying them as documents or reinserting them back into the Event Store 108.

### Event Store

At the core of the Audit Subsystem 100 is the Event Store 108, which preferably stores actively reportable event records. Preferably, the Event Store 108 associates an event with one or more of: (a) an action type identifier, (b) an action identifier, (c) a category identifier, and (d) a client or user associated identifier, wherein the action is performed by the executable application. Preferably, the event associated data includes one or more of: (a) an application environment identifier, (b) a computer job identifier, (c) an identifier of an entity responsible for the event, (d) an identifier of a user responsible for the event, (e) an identifier of a type of client location requesting the event, (f) an identifier of a client location associated with requesting the event, (g) an indication of success or failure of the event, (h)— an identifier of an object type acted upon in the event, (i) an identifier of a number of objects acted upon in the event, and (j) an identifier of a datastream including data indicating objects acted upon in the event.

Preferably, the Event Store 108 is a relational database with one table for storing the event records and other tables having one or more of the following extensible reference data:

1. a list of the actions that can be audited (e.g. modify object, display object, etc.),

2. a list of generalized action categories (e.g. create, read, update, delete, execute),

3. a list of the types of client locations from which actions can be initiated (e.g. workstation, Internet Protocol (IP) address, telephone number, etc.), and

4. a list of the types of objects upon which actions can be taken (e.g. document, folder, etc.).

Preferably, each row in the event record table contains information associated with a recorded event.

### Event Data

Preferably, each Event 104 requires one or more of the following event data information:

1. a string representing the application environment in which the event occurred (this is typically used to identify the corporate institution responsible for the event — multiple institutions can be supported simultaneously),

2. an ID representing a background “job context,” if one exists (this is used to link a set of events that are related by a single, non-interactive operation—i.e. no user involvement),

3. a string representing the entity or organization responsible for the event (this is used to subdivide the responsible institution but subordinate organizations—e.g. separate hospitals owned by a single corporate institution),

4. the time when the event was initiated,

5. the time when the event completed,

6. the user responsible for the event (this is a real person who is accountable for the event),

7. a reference to the action category in which the event fits,

8. a reference to the actual action performed during the event,

9. a reference the type of client location that requested the event,

10. the name or identifier associated with the requesting client location (this represents the actual origin, or place, from which the event action was initiated such as a workstation or server),

11. an indication of the success or failure of the event (0 for success or an error code),

12. the type of object acted upon,

13. identifying data that represents the primary object acted upon (if applicable) including:

a. an object sub-type (such as the folder type if the object type is “folder”),

b. an object index name (such as “med rec no” if the object is a medical record folder),

c. the value of the object index (such as “12345” if the object index is “med rec no”), and

d. the object name (such as the patient name if the object is a clinical folder associated with a particular patient),

14. a count of the number of objects involved in the event if the event acts upon a list, and

15. a data stream describing the list of objects involved in the event if the event acts upon a list.

### Sample Database Design

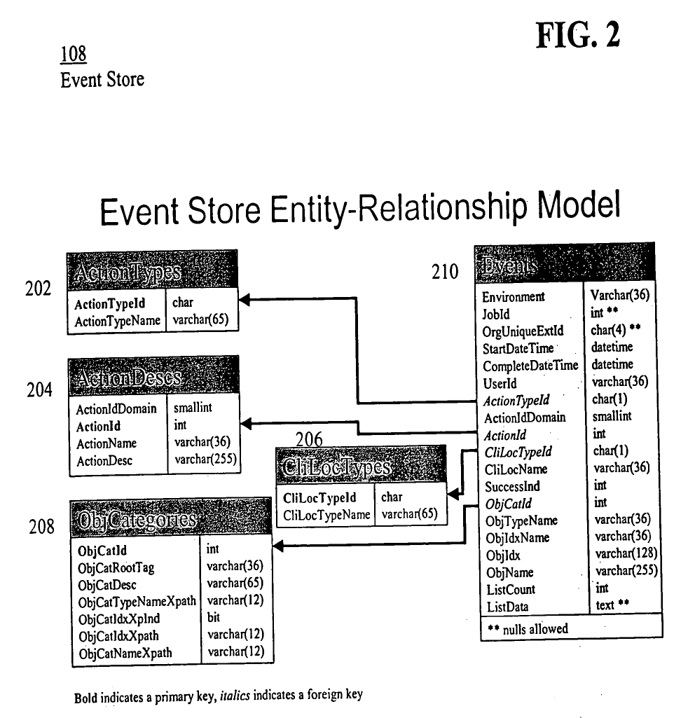

FIG. 2 illustrates a graphic representation of the Event Store 108, implemented using a relational database, in accordance with a preferred embodiment of the present invention. Preferably, the relational database is implemented in a Microsoft® SQL server. FIG. 2 generally describes four reference data tables including an ActionTypes table 202, an ActionDescs table 204, a CliLocTypes table 206, an ObjCategories table 208, and an Events table 210. ActionTypes table 202, ActionDescs table 204, CliLocTypes table 206, and ObjCategories table 208 are further described herein as Tables 2, 3, 4, and 5, respectively. Preferably, Tables 2, 3, 4, and 5 include initially loaded information. Preferably, the information in Tables 2, 3, 4, and 5 are defined specifically for use with a document imaging system, but may be readily extended for other document imaging systems and/or other any other type (e.g., non-document imaging type) of applications. Preferably, the Events table 210 stores Events 104 that may occur.

Table 2 illustrates a action types, in accordance with a preferred embodiment of the present invention.

TABLE 2
ActionTypes

| ActionTypeId | ActionTypeName |
|---|---|
| C | Create |
| R | Read |
| U | Update |
| D | Delete |
| E | Execute |

Table 3 illustrates action descriptions, in accordance with a preferred embodiment of the present invention.

TABLE 3
ActionDescs

| ActionIdDomain | ActionId | ActionName | ActionDesc |
|---|---|---|---|
| 0x00c2 | 0x00c20000 | <36 char function name> | <255 char function description> |
| 0x00c2 | 0x00c20001 | Acquire Document | Document Created. |
| 0x00c2 | 0x00c20002 | Store Object | Object Inserted/Replaced. |
| 0x00c2 | 0x00c20003 | Retrieved Document | Document Retrieved. |
| 0x00c2 | 0x00c20004 | Insert Objects | Base level insertion routine |
| 0x00c2 | 0x00c20005 | Replace Objects | Base level replace routine |
| 0x00c2 | 0x00c20006 | Delete Document | Base level delete routine |
| 0x00c2 | 0x00c20007 | Update Document | Base level update routine |
| 0x00c2 | 0x00c20008 | Retrieve Document List | Base level retrieval routine |
| 0x00c2 | 0x00c20009 | Render Document | Base level rendering routine |
| 0x00c2 | 0x00c2000a | Duplicate Document | Base level copy routine |
| 0x00c2 | 0x00c20101 | Create Document Type | Base level creation routine |
| 0x00c2 | 0x00c20102 | Delete Document Type | Base level delete routine |
| 0x00c2 | 0x00c20103 | Update Document Type | Base level update routine |
| 0x00c2 | 0x00c20201 | Create File Format | Base level creation routine |
| 0x00c2 | 0x00c20202 | Delete File Format | Base level delete routine |
| 0x00c2 | 0x00c20203 | Update File Format | Base level update routine |
| 0x00c2 | 0x00c20301 | Create Folder | base level creation routine |
| 0x00c2 | 0x00c20303 | Delete Folder | base level delete routine |
| 0x00c2 | 0x00c20304 | Update Folder | base level update routine |
| 0x00c2 | 0x00c20305 | Retrieve Folder | base level retrieval routine |
| 0x00c2 | 0x00c20306 | Open Folder | Access the contents of a folder |
| 0x00c2 | 0x00c20307 | Rejected Document | Rejected a document during filing |
| 0x00c2 | 0x00c20308 | Rejected Folder | Rejected a folder during index |
| | | | revision |
| 0x00c2 | 0x00c20309 | Batched Document | Batched a document during filing |
| 0x00c2 | 0x00c20401 | Create Folder Type | base level creation routine |
| 0x00c2 | 0x00c20402 | Delete Folder Type | base level delete routine |
| 0x00c2 | 0x00c20403 | Update Folder Type | base level update routine |
| 0x00c2 | 0x00c20501 | Filing Insert Objects | base level insertion routine |
| 0x00c2 | 0x00c20502 | Filing Remove Objects | base level delete routine |
| 0x00c2 | 0x00c20601 | Create Audit Report Type | add a new Audit Report Type |
| 0x00c2 | 0x00c20602 | Delete Audit Report Type | delete an Audit Report Type |
| 0x00c2 | 0x00c20603 | Update Audit Report Type | revise Audit Report Type |
| | | | information |
| 0x00c2 | 0x00c20604 | Upload Audit Report Type | update Audit Report Type |
| | | | routine(s) |
| 0x00c2 | 0x00c20701 | Run Audit Report | generate audit report |
| 0x00c2 | 0x00c20702 | Schedule Audit Report | schedule an audit report to be run |
| 0x00c2 | 0x00c20703 | Unschedule Audit Report | deletion of scheduled audit report |
| 0x00c2 | 0x00c2f000 | Logon/Logoff | Time of user activity in |
| | | | Document Imaging |
| 0x00c2 | 0x00c2f100 | Delete Rights | Delete rights for a user. |
| 0x00c2 | 0x00c2f101 | Store Rights | Store rights for a user. |
| 0x00c2 | 0x00c2f102 | Create Entity | Create an entity in the security |
| | | | system. |
| 0x00c2 | 0x00c2f103 | Delete Entity | Delete an entity in the security |
| | | | system. |
| 0x00c2 | 0x00c2ffff | Unknown Function | Unknown function |
| 0x00d7 | 0x00d700fa | IndexSync Online | Process online transaction |
| 0x00d7 | 0x00d700fb | IndexSync Batch | Process batch PADI transaction |
| | | | file |
| 0x00d7 | 0x00d70200 | Olc Process report | Olc process report created docs |
| 0x00d7 | 0x00d70201 | Olc Bypass report | Olc bypass report due to Bursting |
| | | | table option |
| 0x00d7 | 0x00d70202 | Olc Recovery report | Olc deleting documents for |
| | | | recovery processing |
| 0x00d7 | 0x00d70203 | Olc Abandoned report | Olc process report abandoned |
| | | | docs |
| 0x00d7 | 0x00d70204 | Olc Discarded owners | Olc process discarded owner docs |
| 0x00d7 | 0x00d70205 | Olc Discarded report | Olc process discarded docs |
| 0x00d7 | 0x00d70206 | Olc Batched owners | Olc process batched owners |
| 0x00d7 | 0x00d70207 | Olc Rejected owners | Olc process rejected owners |
| 0x00d7 | 0x00d7ffff | Unknown Function | Unknown function |
| 0x00c0 | 0x00c00001 | Create Document | Base level creation routine |
| 0x00c0 | 0x00c0ffff | Unknown Function | Unknown function |

Table 4 illustrates client location types, in accordance with a preferred embodiment of the present invention.

TABLE 4
CliLocTypes

| CliLocTypeId | CliLocTypeName |
|---|---|
| <space> | Not Applicable |
| 1 | Machine Name |
| 2 | IP Address |
| 3 | OS Device ID |
| 4 | Phone Number |

Table 5 illustrates object categories, in accordance with a preferred embodiment of the present invention.

TABLE 5
ObjCategories

| | | | | ObjCatIdx | | |
|---|---|---|---|---|---|---|
| ObjCatId | ObjCatRootTag | ObjCatDesc | ObjCatTypeNameXpath | XpInd | ObjCatIdxXpath | ObjCatNameXpath |
| 0 | Object | Undefined | @ObjectTypeName | 0 | ObjectIdx | ObjectName |
| 1 | Owner | Folder | @OwnerTypeName | 1 | PrimaryIdxName | OwnerName |
| 2 | Document | Document | DocType/@DocTypeName | 0 | @Key | Device |
| 3 | Report | Report | @ReportName | 0 | ReportType | AqSource |
| 4 | Trx | Transaction | @TrxFormat | 0 | @TrxEvent | InterfaceName |
| 5 | Destination | Output | @DestTypeName | 0 | <blank> | DestName |
| | | Destination | | | | |
| | | System or | | | | |
| | | Device | | | | |
| 6 | DocType | Document | @DocTypeName | 0 | @DocTypeId | Desc |
| | | Type | | | | |
| 7 | FileFormat | File Format | FileExt | 0 | @FileFmtId | FileFmtDesc |
| 8 | OwnerType | Folder Type | @OwnerTypeName | 0 | @OwnerTypeCode | OwnerTypeDescr |
| 9 | AuditReport | Audit Report | AuditReportDef/AuditRptName | 0 | AuditReportDef/ | @Name |
| | | | | | AuditRptDesc | |
| 10 | AuditReportDef | Audit Report | AuditRptName | 0 | AuditRptDesc | <blank> |
| | | Type | | | | |

### Write Event Record Service

The Audit Subsystem 100 exposes a Write Event Record Service 106 that allows any software component or system to log a record of a single event. Preferably, this service is exposed via one or more of the following mechanisms:

as a native C++ function,

as a method in a Windows ActiveX control, and

as an HTTP-POST service.

These mechanisms take as arguments the information that defines an event (as listed above in the Event Store 108—Event Data). The C++ arguments can be taken in native data types, as are understood by software developer skilled in the relevant art. The ActiveX Control and HTTP-POST service takes the arguments in a single XML stream such as the sample stream below:

<Event>

<StartDateTime>event_start_time</StartDateTime>
<ActionType><ActionTypeId>action_type_id</ActionTypeId>
</ActionType>
<ActionDesc><ActionId>action_id</ActionId></ActionDesc>
<SuccessInd>success_return_code</SuccessInd>
<CliLocType><CliLocTypeId>client_location_type_id
</CliLocTypeId></CliLocType>
<CliLocName>client_location_name</CliLocName>
<ObjInfo>object_xml_including_all_object_information
</ObjInfo>
<ListCount>numeric_count_or_−1_if_no_list</ListCount>
<ListData>list_data_if_any</ListData>

</Event>

### Functional Design

Preferably, the Write Event Record Service 106, once invoked, performs the following steps.

1. The arguments are parsed into native data types if taken as XML (e.g., the action id is translated into a numeric).

2. Configuration is checked to determine whether the action is one being stored (if not, then no further processing is done).

3. The service uses data access tools (such as, but not limited to, ADO.NET, ADO, OLEDB, or ODBC) to store a record in the Event Store's Events table.

### Reporting

Generating an audit report from the Audit Subsystem 100 involves making a query over the data in the Event Store 108, and then formatting the query results into a user-readable format. To report on different subsets of event data the Audit Subsystem 100 supports the definition of Audit Report Types. Preferably, each Audit Report Type defines the parameters used for the Event Store query (this specifies the subset of event data retrieved) and how to transform the resultant list of events into meaningful output.

Preferably, XML is used extensively during the generation of audit reports. The Event Store query returns the query results as an <EventList> XML stream. The resulting XML is then transformed into an HTML formatted report using an XSL Style Sheet. An example of the XML streams for an event and an event list are as follows.

Event:

<Event>

<Environment>env</Environment>
<JobId>job_id</JobId>
<OrgUniqueExtId>org_unique_ext_id</OrgUniqueExtId>
<StartDateTime>start_date_time</StartDateTime>
<CompleteDateTime>complete_date_time</CompleteDateTime>
<UserId>user_id</UserId>
<ActionType>

<ActionTypeId>action_type_id</ActionTypeId>
<ActionTypeName>action_type_name</ActionTypeName>

</ActionType>
<ActionDesc>

<ActionIdDomain>action_id_domain</ActionIdDomain>
<ActionId>action_id</ActionId>
<ActionName>action_name</ActionName>
<ActionDesc>action_description</ActionDesc>

</ActionDesc>
<SuccessInd>success_code</SuccessInd>
<CliLocType>

<CliLocTypeId>cli_loc_type_id</CliLocTypeId>
<CliLocTypeName>cli_loc_type_name</CliLocTypeName>

</CliLocType>
<CliLocName>cli_loc_name</CliLocName>
<ObjCategory>

<ObjCatId>object_category_id</ObjCatId>
<ObjCatDesc>object_category_description</ObjCatDesc>

</ObjCategory>
<ObjTypeName>obj_type_name</ObjTypeName>
<ObjIdxName>obj_idx_name</ObjIdxName>
<ObjIdx>obj_idx</ObjIdx>
<ObjName>obj_name</ObjName>
<ListCount>list_count</ListCount>
<ListData>list_data</ListData>

</Event>

Event List:

<EventList>

<Event> ... </Event>
...
<Event> ... </Event>

</EventList>

### Audit Report Types

Preferably, an Audit Report Type consists of one or more four distinct parts:

1. a type name (for internal system reference),

2. a description (to be displayed to the user),

3. a set of parameters used to query the Event Store, and

4. a set of instructions on how to transform the query results into a formatted report.

The Event Store query parameters preferably consist of a set of absolute values and possibly some user defined values to match with a subset of the Event data. The parameters are registered as part of the Audit Report Type as an incomplete set of HTML entry field tags (possibly including <input> and <select> tags). Then, the HTML entry field tags are embedded in a data entry form presented to the user. Preferably, the <input> and <select> fields are then used to collect more specific query criteria. The transform instructions are registered as part of the Audit Report Type as an XSL Style Sheet that is used to transform the query result XML into a formatted HTML report.

### Sample Audit Report Type

A sample Audit Report Type is shown as follows.

An Audit Report Type includes one or more four distinct parts:

1. a type name (for internal system reference),

2. a description (to be displayed to the user),

3. a set of parameters used to query the Event Store, and

4. a set of instructions on how to transform the query results into a formatted report.

A sample of each part of the Audit Report Type is described as follows.

Name

The name is for internal use by the Audit Subsystem. It is preferably a string with a reasonable limit (e.g., 12 characters).

The audit report name used in this section's example is ActivitySumm.

### Description

The description is used for a user reference. The description is displayed in the user interface to specify this report type. The description for the ActivitySumm report type is Activity Summary by User.

### Event Store Query Parameters

The event store query parameters specify what values are used when performing a query over the Event Store. Preferably, these parameters are represented in an XML stream such as:

<Event>

<CompleteDateTime>

<BeginRange>Thu, Oct 10, 2002 00:00:00 -0400</BeginRange>
<EndRange>Fri, Oct 11, 2002 00:00:00 -0400</EndRange>

</CompleteDateTime>
<UserId>qatest1</UserId>
<ActionId>12713985,12713987,12713993,12775424</ActionId>
<SuccessInd>0</SuccessInd>
<JobId>0</JobId>
<SortCriteria>DateOnly CompleteDateTime, UserId,
CompleteDateTime</SortCriteria>

</Event>

For any given report type, some of these values may be absolute (i.e. the user cannot change them) and some may be user configurable. Preferably, these definitions are expressed using an incomplete HTML stream that can be embedded in the larger Report Generation process 114. Absolute values are expressed in hidden INPUT fields and user configurable fields are expressed in displayed INPUT or SELECT fields. The HTML for the ActivitySumm report type is contained in a file called IasActivitySumm.htm.

### Transform Instructions

To present a report in user readable format, results of the report event query are preferably transformed from XSL to an HTML document using an XSL style sheet. Each report type has a specific style sheet made to present the query results in a way that makes sense for the type of report being generated. The Report Generation process 114 uses the style sheet to produce the output that is returned to the process calling the report. The XSL style sheet for the ActivitySumm report type is contained in a file called IasActivitySumm.xsl.

### Report Generation

Preferably, the Report Generation process 114 implements the Event Store query and XML-to-report transform. Architecturally, this process begins with an identified set of query criteria and ends with an HTML formatted report.

### Functional Design

The following steps implement the Report Generation process.

1. An external process including, but not limited to, the Reporting User Interface 110 or the Scheduled Reporting process 112 invokes the Report Generation process 114. The external process passes a set of values to be used as the Event Store query criteria and the applicable XSL Style Sheet for the XML-to-report transform.

2. One of two queries is then performed using standard Windows data access methods including, but not limited to, ADO.NET, ADO, OLEDB, and/or ODBC). The SQL used to perform this query is directed to format the results as an XML stream. Either

a) a single, straight SQL query is made using the criteria to match records in the Event Store, or

b) the initial criteria is used to query a list of records, then a list of job contexts (i.e. Jobld's) are-compiled from these results and used to retrieve records associated with those jobs.

3. The XML results are read into an MS-XML parser object (or other industry standard tool for XML manipulation) to apply the XSL Style Sheet and transform the query results into an HTML report.

4. The HTML report is returned to the calling process.

### Sample Query Criteria

A sample query criteria used for an Activity Summary by User Report is as follows.

<Event>

<CompleteDateTime>

<BeginRange>Thu, Oct 10, 2002 00:00:00 -0400</BeginRange>
<EndRange>Fri, Oct 11, 2002 00:00:00 -0400</EndRange>

</CompleteDateTime>
<UserId>qatest1</UserId>
<ActionId>12713985,12713987,12713993,12775424</ActionId>
<SuccessInd>0</SuccessInd>
<JobId>0</JobId>
<SortCriteria>DateOnly CompleteDateTime, UserId,
CompleteDateTime</SortCriteria>

</Event>

### Sample Query Results

An example of query results for an “Activity Summary by User Report” is shown as follows.

Table 1 illustrates an activity summary by user report, in accordance with a preferred embodiment of the present invention.

TABLE 1
Activity Summary by User Report

| | | |
|---|---|---|
| Start Date: | Thursday, October 10, 2002 12:00:00 AM | Record Count: 10 |
| End Date: | Friday, October 11, 2002 12:00:00 AM | |

Date: 2002-10-10
User: qatest1

| | | | |
|---|---|---|---|
| Work Station | Logon Time | Logoff Time | Login Time |
| QAWKSTA1 | 2002-10-10 06:12:25 | 2002-10-10 16:37:03 | 0 10:24:38 |

| Documents | Documents | Documents | Documents | Pages | Documents | Pages | Login |
|---|---|---|---|---|---|---|---|
| Displayed | Imported | Exported | Acquired | Acquired | Printed | Printed | Time |
| 8 | 1 | 0 | 0 | 0 | 0 | 0 | 0 10:24:38 |

Totals For 2002-10-10

| Documents | Documents | Documents | Documents | Pages | Documents | Pages | Login |
|---|---|---|---|---|---|---|---|
| Displayed | Imported | Exported | Acquired | Acquired | Printed | Printed | Time |
| 8 | 1 | 0 | 0 | 0 | 0 | 0 | 0 10:24:38 |

Grand Totals

| Documents | Documents | Documents | Documents | Pages | Documents | Pages | Login |
|---|---|---|---|---|---|---|---|
| Displayed | Imported | Exported | Acquired | Acquired | Printed | Printed | Time |
| 8 | 1 | 0 | 0 | 0 | 0 | 0 | 0 10:24:38 |

Scheduled Reporting

The Scheduled Reporting process 112 provides a means to generate reports at regular intervals without user attendance. Configuration drives this process with zero or more sets of Event Store query criteria, each of which may be used to generate a report at daily, weekly, monthly, or yearly intervals. Preferably, the Scheduled Reporting process 112 executes once each day, reading the list of reports to generate and invoking the Report Generation process 114 for the reports configured for generation on that day.

### Configuration

The configuration for Scheduled Reporting process 112 contains a list of scheduled reports. Preferably, each scheduled report includes one or more of the following information: a scheduling reference name, the transformation XSL Style Sheet, the frequency of generation (e.g., daily, weekly, monthly or yearly), the time zone to use for date/time display, the document type (e.g., listed by DocTypeName) that are used when archiving the generated report, and the criteria used to query the Event Store. The configuration is preferably stored as an XML stream similar to the following:

<ScheduledReports>

<Report RefName=“Rpt1” StyleSheet=“IasAccessByRec.xsl”
Frequency=“Daily”
TzOffset=“−4” TzString=“EDT” DocTypeName=“RecAccess”
LastRun=“some_date_time”>

<Event>

<Environment>DI24</Environment>
<ActionIdDomain>194</ActionIdDomain>
<SuccessInd>0</SuccessInd>
<ObjCatId>1</ObjCatId>
<ObjTypeName>MEDREC</ObjTypeName>
<JobId>0</JobId>
<SortCriteria>DateOnly CompleteDateTime, UserId,
CompleteDateTime</SortCriteria>

</Event>

</Report>

</ScheduledReports>

### Functional Design

Preferably, the Scheduled Reporting process 112 is implemented as a service that is scheduled to execute one time per day at a time of low system activity (e.g., typically 2 am). This scheduling is preferably done using the Windows Schedule Service, as is well known to a software programmer skilled in the art of Windows® programming. The following steps implement the Scheduled Reporting process 112.

1. Read the configuration for the list of scheduled reports. For each entry in the list, perform steps 2 through 4.

2. Determine the current localized date/time based on the time zone saved for the report.

3. Determine whether the report is generated for any timeframe between the LastRun date and the current date/time. Preferably, this is performed using the following logic for each frequency.

If the frequency is “daily” then the report is generated for each complete 24 hour day that has passed between the LastRun date/time and the current date/time.

If the frequency is “weekly” then the report is generated for each complete week (starting on a configurable day) that has passed since the LastRun date/time.

If the frequency is “monthly” then the report is generated for each complete month that has passed since the LastRun date/time.

If the frequency is “yearly” then the report is generated for each complete year that has passed since the LastRun date/time.

4. Invoke the Report Generation process 114 for each timeframe (i.e. day, week, month or year) since the LastRun date/time. Pass every generated report 128 to a Background Acquisition process (not shown in FIG. 1) to be archived for future access.

### User Interfaces

The Audit Subsystem 100 includes two types of user interfaces including Maintain Audit Report and Generate Audit Reports. The Maintain Audit Reports permit adding, revising, and/or deleting Report Types. The Generate Audit Reports permits request on demand or scheduled generation of audit reports.

### Record Purge

The size of the active audit record database can grow in size relatively quickly. Therefore, it is preferred to keep the audit records in a database as long as they are required for active reporting. The Record Purge process 116 cleans out unnecessary event records to conserve storage space. Preferably, the Record Purge process 116 also archives a subset of the purged records just in case they are needed for historical reporting in the future.

For the purpose of Record Purge, audit records are classified in one or more of the following three categories:

1. user activity records (e.g., events associated with a user action),

2. operational activity records (e.g., events associated with background system activity), and

3. performance data only records (e.g., records that track the performance of potential bottleneck processes that are part of other larger events, but do not constitute an event by themselves).

The records in each of these categories are purged at different ages (i.e., when they are older than some configured number of days) as they differ in the amount of time they are needed for active reporting. The preferred time intervals are described as follows.

The “performance data only” records are used solely for performance monitoring and troubleshooting and are therefore purged quickly. The model purge age for these records is seven days. These records are not needed for historical reporting and are not archived.

The “operational activity” records are typically used to generate model scheduled operational reports (e.g., the OLC Activity Report) and are not preferred for historical reporting. Since it may be necessary to follow up on operational activity, the preferred purge age for these records is thirty-one days. These records are not archived since their information is aggregated in archived reports.

The “user activity” records are used for productivity and accountability reporting. In short, it is these records that contribute to the ability to answer such questions as “What has each employee been doing?” and “Who did what to a particular set of data?” Since these records are important in the light of security policies, and since they are used for Health Insurance Portability And Accountability Act (HIPAA) reporting, the preferred purge age for these records is ninety-two days. Because these records are needed for historical reporting, they are exported from the Event Store 108 as an XML stream and archived in the preferred document imaging system for future retrieval and historical reporting.

### Functional Design

Preferably, the Record Purge process 116 is scheduled to execute once per day. Once invoked, the following steps are performed.

1. The purge age for each record category is read from configuration.

2. A record expiration date is computed for each record category by subtracting the purge age from the current date (i.e., records older than the computed date are subject to purge).

3. A query is performed to extract “user activity” records that are subject to purge. This query formats the extracted records as an<EventList> XML stream (see the sample <EventList> stream herein).

4. The exported “user activity” records are sent to a Background Acquisition system (not shown in FIG. 1) to be stored in the document imaging archive as a single XML document.

5. Expired records are removed from the Event Store 108 using a “delete” SQL statement against the Events table.

### Historical Reporting

Preferably, the Historical Reporting includes both the ability to view archived event records (referred to as “Historical Review 120”) and the ability to restore them to the Event Store 108 for active reporting (referred to as “Record Restore 122”).

### Historical Review Functional Design

Preferably, the Historical Review process 120 provides the ability for the Audit Subsystem 100 to retrieve the extracted Event Record XML documents from the archive, and display them in a document imaging application. This is done via standard document imaging retrieval and viewer mechanisms. The XML documents are filed in a retrievable folder, displayable in a Folder Display window, and viewable in a Document Display window. When displayed, the XML document uses the XML/XSL template merge capabilities of an image viewer to display the document in user readable format.

### Record Restore Functional Design

Preferably, the Record Restore process 122 reads one or more event record XML documents (e.g., retrieved from the document imaging archive) and re-inserts those records back into the Event Store 108. The following steps implement the Record Restore process 122.

1. A user retrieves a list of event record XML documents from the document imaging archive using standard document imaging application functionality. Preferably, the retrieval is done either by retrieving the folder containing these documents or by retrieving the documents themselves. Either way, they are displayed in the Folder Display window.

2. The user selects a subset of these event record XML documents and invokes the “Record Restore” process over them from the document imaging application. This is launched from a “Restore Audit Records” function in the Folder Display window. Preferably, the “Restore Audit Records” function invokes the Record Restore process 122 asynchronously and returns application control to the user.

3. The Record Restore process 122 executes in background and performs the following steps:

a. Each event record XML document is retrieved from the archive.

b. Each XML document is converted into a series of “insert” SQL statement targeted at the Event Store “Events” table.

c. The generated SQL statements are executed to make the records available for active reporting using the Audit Subsystem 100 reporting mechanisms.

An example of the Audit Report Query Results is describe as follows.

In a healthcare enterprise, the Audit Subsystem 100 advantageously tracks medical record access, medical procedure referrals, medical procedure authorizations, medical eligibility verification, procedure orders and other communications associated with healthcare delivery between multiple, different organizations. This tracking function provides a healthcare enterprise (e.g., a hospital) the capability to track medical communications outside of the particular organization. For example, if a patient gets referred from Hospital A to Hospital B and the patient needs to bring significant documents, films or images, the referral is controlled and tracked from Hospital A and the necessary documents images etc. are accessible at Hospital B from the document storage system acting as a central repository. Further, if Hospital B sends the patient to Hospital C, this referral is authorized, monitored, and tracked via the audit and document storage system.

The Audit Subsystem 100 also advantageously enables a patient that visits Hospital B to grant permission at Hospital B and to record that he granted permission to access his records retained in the central document storage system by Hospital A. Alternatively, the system may initiate a request to the multi-institution document storage system to seek any records held for the patient by Hospital A.

### Operations Monitoring and Functions

### Monitoring Job Statuses

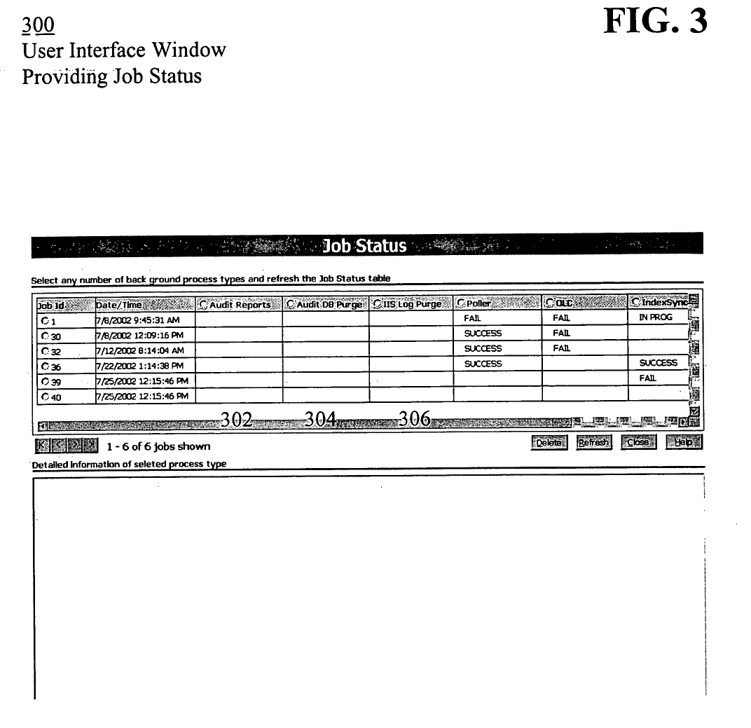

FIG. 3 illustrates a user interface window providing job status 300, in accordance with a preferred embodiment of the present invention. The Job Status function enables system administrators and business office managers to review and in some cases, edit/reprocess failed system background jobs. From an Operations menu, a user selects “Job Status” to display the Job Status user interface window 300.

When a user first accesses the Job Status window 300, the top half of the screen lists jobs. A job can have one of three statuses (and additional statuses in other embodiments)

1. FAIL (i.e., job failed entirely or in part)

2. IN PROG (i.e., job in progress)

3. SUCCESS (i.e., job finished successfully)

### Job Types

Preferably, the job types include, without limitation, Audit Reports 302, Audit Database Purge 304, and Internet Information Services (IIS) Log Purge 306. For the Audit Reports 302 type, a job runs each time a scheduled audit report runs. For the Audit Database Purge 304 type, a job runs daily that backs up the audit database and purges it to prevent the audit database from growing too large. For the IIS Log Purge 306 type, an IIS monitors activity on an Internet Information Manager Server. A job runs that purges the log file generated by IIS.

### Audit Reports

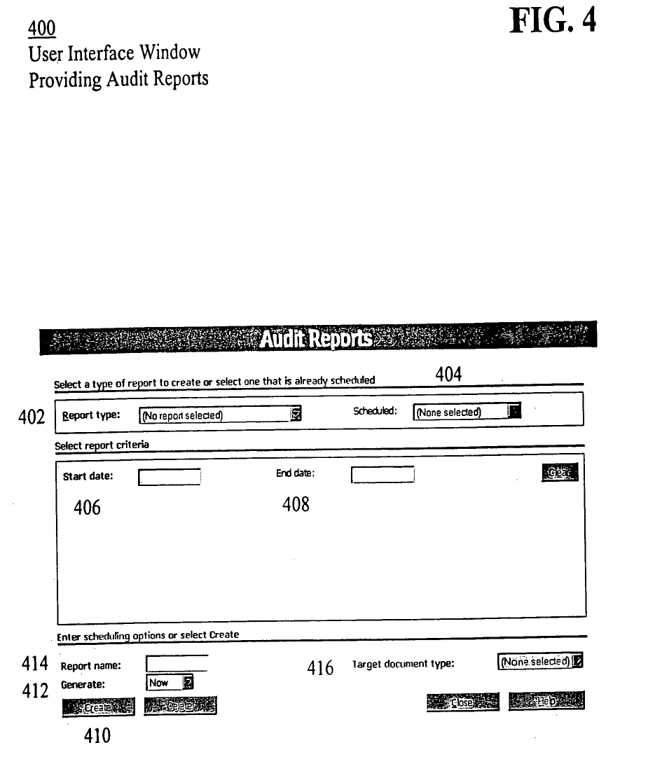

FIG. 4 illustrates a user interface window providing audit reports 400, in accordance with a preferred embodiment of the present invention. The audit reports provide system administrators and office managers statistics on user activity and/or productivity, as well as system processing statistics. From the “Operations” menu, select “Audit Reports” to display the audit reports window 400. The following types 402 of Audit Reports are available.

1. Access History of Selected Record.

2. Activity Detail by User.

3. Activity Summary by User.

4. Concurrent Activity.

5. Documents Accessed by User.

6. Folders Accessed by User.

7. Online Clerk Activity.

### Generating Reports

Preferably, the steps for generating any of the Audit Reports are the same. The differences lie in the fields that a user can select to generate the queries. For field definitions, see Audit Reports Field Descriptions herein below. For a description of each report, see Report Descriptions herein below. Preferably, the sort order for each report is listed at the bottom of each reports description section. A user generates a report by performing the following steps.

1. Select the desired report type 402 from the “Report” dropdown list.

2. Enter a “Start date” 406 and optionally the “End date” 408. If the user leaves the End date blank, the report is generated for the day specified in the Start date field.

3. Enter additional fields to narrow the scope of the report.

a. The more fields entered, the more focused the report will be.

b. Entering large date ranges will increase report generation time.

c. Some fields allow a user to select multiple values. A user may use the Shift and Ctrl keys to select mulitple values.

4. Click the “Create” button 410 to create the Audit Report.

Preferably the results of the query appear in a separate display window. The user has the ability to schedule any of the reports to run on a regular basis. See “Scheduling Reports to Run on a Daily, Weekly, or Monthly Basis” herein below.

Saving and Viewing Options

A user has several options for viewing and saving Audit Reports.

1. Scheduled reports are automatically saved by date to the AUDITRPTHTM folder. See “Scheduling Reports to Run on a Daily, Weekly, or Monthly Basis” herein below.

2. The report can also be viewed (if the generating job is still in the queue) from the Job Status window.

3. Additionally, when a user generates the report on demand, the report will appear in a separate Internet Explorer (IE) window. From the File menu, a user selects “Save As . . . ” to save the report. If desired, a user could import the saved report back into the Audit Subsystem 100.

Scheduling Reports to Run on a Daily, Weekly, or Monthly Basis

Any of the Audit Reports can be scheduled 404 to run automatically on a daily, weekly, or monthly basis, where

1. A day starts at 12:00 AM and ends at 12:00 PM.

2. A week starts Monday at 12:00 AM and ends at Monday at 12:00 PM.

3. A month starts the first at 12:00 AM and ends at 12:00 AM on the first day of the next month.

Preferably, the reports are scheduled as follows.

1. Model jobs are scheduled to run at 2:00 in the morning for the previous day. This is typically an off-peak time.

2. If the user is an application specific provider (ASP) customer on Pacific Time, and their reports are showing up a day late, an adjustment may be made to the schedule time of reports.

3. If for some reason, part of the system goes down and a scheduled report fails to generate, the very next time the report generator runs it will compensate and report the missed time period as well as the current one.

A report is scheduled as follows.

1. Select the Report type 402.

2. Select the report criteria to generate the scheduled report. Do not enter a Start date 406 or an End date 408.

3. In the “Generate” field 412, select Daily, Weekly, or Monthly.

4. Enter a descriptive Report name 414.

5. Select the “Target document type” 416 to associate with this report. This document type should correspond to the type of report being generated as follows.

a. Access History of Selected Record (ACCESHIS)

b. Activity Detail by User (ACTDETL)

c. Activity Summary by User (ACTSUMM)

d. Concurrent Activity

e. Documents Accessed by User (DOCACCES)

f. Folders Accessed by User (FOLDACES)

g. Online Clerk Activity (OLCACT)

Preferably, if a user creates their own Audit Report and schedules it to run, the user either select a document type of a similar report or creates a new document type that will not be associated with any bursting and filing rules.

6. Click the “Create” button 410. A confirmation prompt and window will appear.

### Audit Reports Field Descriptions

This section contains descriptions for fields that a user can query when generating Audit report. Not all fields appear on every report. Preferably, the fields that display more than one option allow a user to select more than one item by using Shift+select, Ctrl+select, or a combination of the two (e.g., Shift+select a range then Ctrl+select an additional single item).

TABLE 6

| Item | Description |
|---|---|
| Start date | Date to start the query from. |
| End date | Date to end the query with. If left blank, this field will |
| | default to Start date value (i.e., the report will only |
| | cover one day). |
| Action | Select one or more document imaging functions to |
| | monitor (e.g., how many times was a retrieve document |
| | function performed). |
| Document type | Select one or more document types (i.e., any other |
| | query option specified will relate to this document |
| | type(s)). |
| Environment | This field identifies which environment to query from |
| | along with organization identifier (may not be present, |
| | if set up as a single organization). This value is located |
| | in the virtual root of the of the web address after the |
| | domain/server name variable. |
| Folder type | Select one or more folder (i.e., any other query option |
| | specified will relate to this Folder type(s)). |
| Index value | The value entered in this field depends on the option |
| | selected in the Report on field. For example, if a user |
| | is reporting on a medical record folder, select Folder |
| | from the Report on field, select MEDREC from the |
| | Type name field, and enter the Medical Record number |
| | in the Index value field. |
| Report on | This field is available on Activity Detail and Activity |
| | Summary reports. The data that are displayed will vary |
| | depending on whether the report is a summary or detail. |
| | For example, if a user selects Transaction for the |
| | activity detail report, the report will contain every detail |
| | stored in the Audit databases for the transaction. |
| | However, for a summary report, a user would only |
| | generate totals. |
| | File format - Statistics on file format maintanance |
| | actions (i.e., create, revise, delete actions from the File |
| | Formats Types option on the Administrator menu). |
| | Report - Statistics on the Report name/Report types |
| | processed by OLC. |
| | Folder type - Statistics on folder type maintanance |
| | actions (i.e., create, revise, delete actions from the |
| | Folder Types option on the Administrator menu). |
| | Note: For folder types created at a user's location, |
| | the user will have to know which field is designated |
| | as the primary index. |
| | Transaction - Statistics on transactions received by the |
| | Imaging system |
| | Output destination system or device —Audit activity for |
| | a system device or output destination. In the Index |
| | value field, enter the name of a printer, workstation, |
| | scanner, etc., as it appears in the Properties window for |
| | the device. |
| | Document type - Statistics on document type |
| | maintenance actions (i.e., create, revise, delete actions |
| | from the Document Types option on the Administrator |
| | menu). |
| | Document - In the Object Id field, enter the document |
| | pointer. The document pointer is a alphanumeric |
| | string, consisting of a one character application version |
| | identifier (e.g., 1 = 24.0), one character object type |
| | (1 = folder type, 2 = document type), the environment |
| | string (see Environment field), and the Document Id. |
| | Folder - Allows query on a specific folder. Select the |
| | folder type and enter a specific index (e.g., Encounter |
| | No.) in the Index Value field. |
| User name | The User name that a user log's onto the system with. |

### Report Descriptions

### Access History of Selected Record

This report provides detailed system usage statistics for date range selected. The summary statistics are displayed a follows.

1. Start Date—Start date for the report request

2. End Date—End date for the report request

3. Record Count—Total number of records that met the search criteria.

For each date within the search range on which matches were found, the following information is preferably reported.

1. Complete Time—Time when the action listed in the Operation field was performed

2. User Id—Id of user who performed the action listed in the Operation field. This field can also be used to enter the service account for either a Poller or a Receiver to see which folders where updated by these services.

3. Operation—Operation that was performed on the document or folder (e.g., open, add, copy, move, etc.).

4. Object Type Name—Folder or Document type.

5. Object Index—Folder or Document key.

6. Object Name—Value assigned to the primary index of the folder or document (i.e., enrollee name, medical record number, etc.).

7. Object Name Count—For operations where a list of objects is requested (e.g., retrieve folders), this field will list the number of objects returned. For certain folder operations, (e.g., open a folder), this field will list the number of documents in the folder.

The preferred sort order for the Access History of Selected Record report is Date, then User ID, then CompleteDate/Time in ascending order.

### Activity Detail by User

This report provides a detailed summary of information about system usage statistics for each user. The following summary statistics are displayed.

1. Start Date—Start date for the report request.

2. End Date—End date for the report request.

3. Record Count—Total number of records that met the search criteria.

For each user specified, the following information is reported by date.

1. Operation—Operation that was performed on the document or folder (e.g., open, add, copy, move, etc.).

2. Time—Time when the action listed in the Operation field was performed.

3. Object Type Name—Folder or document type.

4. Object Index—Folder or document key.

5. Object Name—Value assigned to the primary index of the folder or document (i.e., enrollee name, medical record number, etc.)

6. Object Name Count—For operations where a list of objects is requested (e.g., retrieve folders), this field will list the number of objects returned. For certain folder operations, (e.g., open a folder), this field will list the number of documents in the folder.

The sort order for the Activity Detail by User report is Date, then User ID, then Action Name (from Action ID), then CompleteDate/Time in ascending order.

### Activity Summary by User

This report provides a summary of system usage statistics for each user. The following summary statistics are displayed.

1. Start Date—Start date for the report request.

2. End Date—End date for the report request.

3. Record Count—Total number of records that met the search criteria.

For each date and user, the following information is provided for the user.

1. Number of documents displayed.

2. Number of documents imported.

3. Number of documents acquired.

4. Number of documents exported.

5. Number of pages acquired.

6. Number of documents printed.

7. Number of pages printed.

8. Login time.

For each user, a history of log on/log off times is provided by date. Additionally, totals of the information listed above are provided for users on a particular day, as well as for users for days specified in the report range. The sort order for the Activity Summary by User report is preferably Date, then User ID, then CompleteDate/Time in ascending order.

### Audit Report Directory

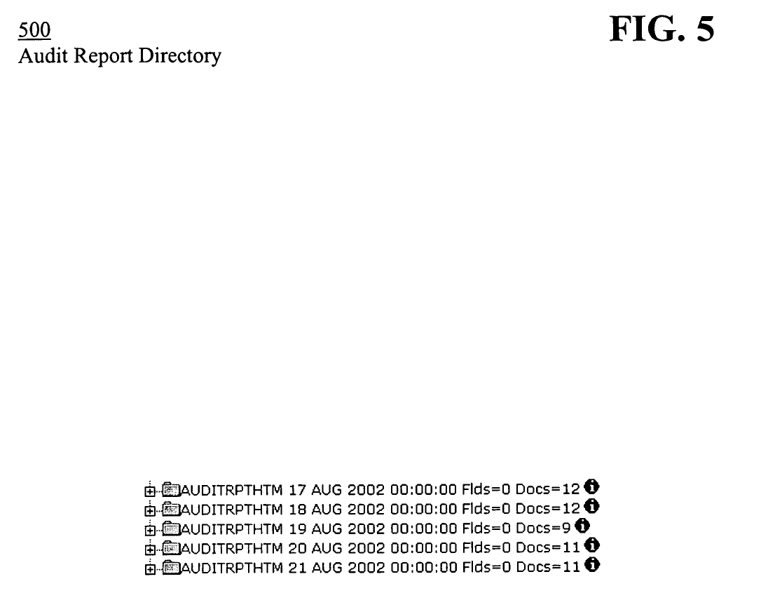

FIG. 5 illustrates an audit report directory 500, in accordance with a preferred embodiment of the present invention. Daily, weekly, and monthly reports are saved in the folder named “AUDITRPTHTM.” The folder is created every day that a report is created. Reports are filed in the folder corresponding to the start date of the report, not the date that the report was created. For example, in the audit report directory 500, the weekly reports covering the period August 19 to August 26 are filed in folder labeled 19 Aug. 2002, even though the report was run on August 26.

### Concurrent Activity

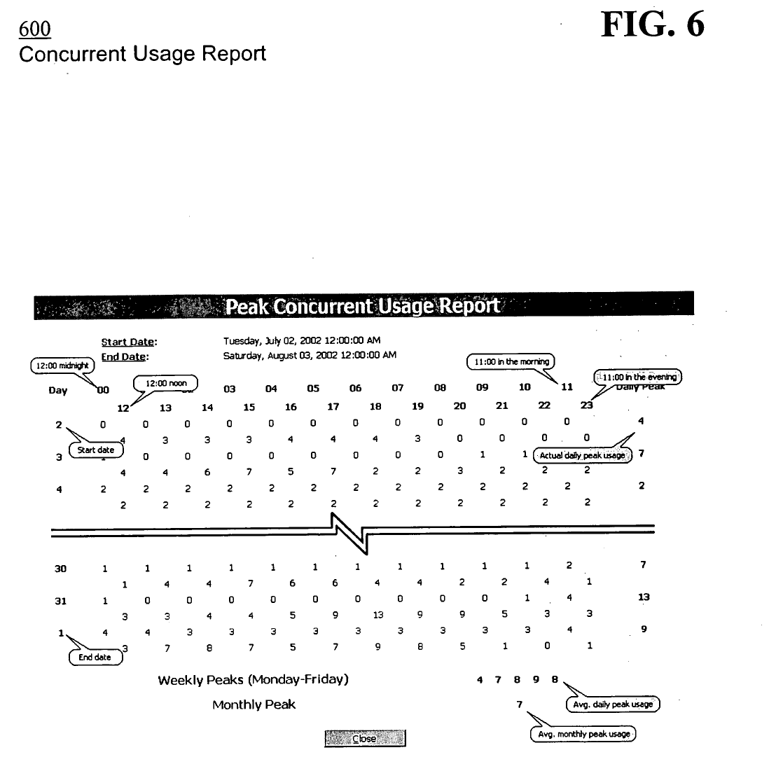

FIG. 6 illustrates a concurrent usage report 600, in accordance with a preferred embodiment of the present invention. The report 600 provides statistics on daily, weekly, and monthly system usage. For the report 600, a concurrent user is a workstation with at least one browser open and connected to the document imaging application. Preferably, users that open multiple browsers on their workstation will not be counted as multiple users. For each day of the reporting period, an hourly peak number of attached workstations is computed, and the largest of these is reported as the daily peak. The daily peaks for Monday through Friday are averaged to compute a weekly peak, then the weekly peaks are averaged to compute a monthly peak.

Although this report can be run on demand, it is intended to be scheduled monthly. If users desire to run it on demand, users preferably need to:

1. enter an End date that is in the past, and

2. enter a Start date that is at least one month prior to the end date entered.

### Documents Accessed by User

This report provides the total number of times an action was performed by document type. The following summary statistics are displayed.

1. Start Date—Start date for the report request.

2. End Date—End date for the report request.

3. Record Count—Total number of records that met the search criteria.

For each date, user, and document type, the following information is provided.

1. Number of documents acquired via background.

2. Number of documents acquired via import.

3. Number of documents acquired via device.

4. Total number of documents acquired.

5. Number pages acquired from device.

6. Number of documents displayed.

7. Number of documents printed.

8. Number of pages printed.

9. Number of documents exported.

The sort order for the Documents Accessed by User report is preferably Date, then User ID, then Object Type Name, then CompleteDate/Time in ascending order.

### Folders Accessed by User

This report provides the number of times an action was performed by folder type for each user. The following summary statistics are displayed.

1. Start Date—Start date for the report request.

2. End Date—End date for the report request.

3. Record Count—Total number of records that met the search criteria.

For each date within the search range on which matches were found and for each user specified, the following information is reported.

1. Time—Time when the action listed in the Operation field was performed.

2. Operation—Operation that was performed on the folder (e.g., open, add, copy, move, etc.).

3. Object Type Name—Folder type.

4. Object Index—Folder key.

5. Object Name—Value assigned to the primary index of the folder (i.e., enrollee name, medical record number, etc.).

6. Object Name Count—For operations where a list of objects is requested (e.g., retrieve folders), this field will list the number of objects returned. For certain folder operations, (e.g., open a folder), this field will list the number of documents in the folder.

The sort order for the Folders Accessed by User report is preferably Date, then User ID, then CompleteDate/Time in ascending order.

### Online Clerk Activity

This report summarizes Online Clerk activity for the specified time period. The following summary statistics are displayed.

1. Start Date—Start date for the report request

2. End Date—End date for the report request

3. Record Count—Total number of records that met the search criteria

For each date, the following is provided.

1. Listing of OLC reports that were processed.

2. Listing of documents that were created.

3. Listing of folders that were created.

4. Listing of folders that were updated.

5. Listing of folders that had documents placed in them.

The information included in any of the lists describe herein may vary. Preferably, the lists include the time of the action and other information relating to index values (e.g., folder type, document type, primary index value, etc.). If there are no items for a particular listing (e.g., no folders were created that day), this category will not appear.

The following summary information is provided for each date.

1. Total number of reports processed.

2. Total number of documents processed.

3. Total number of reports bypassed (see Note 1 immediately below).

4. Total number of recovery reports (see Note 2 immediately below).

5. Total number of documents deleted by recovery (see Note 2 immediately below).

6. Total number of reports with documents abandoned (see Note 3 immediately below).

7. Total number of documents abandoned (see Note 3 immediately below).

8. Average processing time per report.

The sort order for the Online Clerk Activity report is preferably Date, then Action ID Domain (in descending order), then Action ID, then CompleteDate/Time in ascending order.

Note that:

1. OLC can have bursting rules that will bypass a report entirely (i.e., if a user encounters an XYZ report, the user should not process it).

2. Occasionally, a report fails after it has started to process. Some documents may have been processed. In this case, the failed job is sent to the Job Status window 300 in FIG. 3. A recovery report is run which will delete any documents that were processed before the job failed. These documents are added when errors are corrected and the job is reprocessed.

3. Some documents are abandoned because they failed to meet criteria specified as a filter during index extraction (e.g., a user should not process, if the admit date is before a specified date).

### Modifying and Adding Audit Reports

Apart from the Audit reports that come with your system, a user has the options of:

1. creating their own reports (which includes using an existing report as a template to create a new one), or

2. modifying the existing reports on their own system.

Note that:

Reports are created outside of the system using an editor of your choice and then uploaded using the Audit Report Types function on the Administrators menu. For documentation purposes, it is assumed that the user employs an existing report as a template to create a new report. Thus, if the user is editing a model report, the instructions provided in Using an Existing Report as a Template apply.

2. It is the user's responsibility to back up new or modified Audit reports added to their system.

3. If a user edits a model report and discover that it no longer works, a back up version may be recovered from a manufacturer of the system.

### Using an Existing Report as a Template

In most cases, a user will not be creating a new report from scratch. Instead, a user will download an existing report, renaming it, updating it, and uploading it back to the system. Preferably, a sample report query file lists possible fields that can be used when creating the report. Preferably, the file name is IasQueryldentity.htm. Although there is a corresponding style sheet (IasQueryldentity.xsl), a user is better off using the style sheet of a report resembling one they want to pattern their report after.

To download an existing file a user should:

1. Access the Internet Explorer (IE) address line.

2. Add/AuditRpts to the end of the application's web address (i.e., http://mlvv3p7a/XXYY/html/AuditRpts, where “XXYY” is the Unique Organization identifier (ID)).

3. Press Enter to display the following directory, as shown in Table 7.

Table 7 illustrates an audit reports directory 710, in accordance with a preferred embodiment of the present invention.

TABLE 7
Audit Reports Directory

| [To Parent Directory] | |
|---|---|
| 8/8/2002 4:16 PM | 1882 IasAccessByRec.htm |
| 8/23/2002 11:46 AM | 4375 IasAccessByRec.xsl |
| 8/2/2002 4:11 PM | 3267 IasActivityDetl.htm |
| 8/2/2002 4:50 PM | 4714 IasActivityDetl.xsl |
| 8/5/2002 3:49 PM | 3095 IasActivitySumm.htm |
| 7/18/2002 8:52 PM | 14060 IasActivitySumm.xsl |
| 7/31/2002 5:41 PM | 933 IasConcurActivity.htm |
| 8/7/2002 5:55 PM | 91182 IasConcurActivity.xsl |
| 8/21/2002 11:42 AM | 2234 IasDocsAccessed.htm |
| 8/21/2002 11:43 AM | 17958 IasDocsAccessed.xsl |
| 8/8/2002 4:16 PM | 2452 IasFldsAccessed.htm |
| 8/2/2002 5:06 PM | 3827 IasFldsAccessed.xsl |
| 7/30/2002 5:52 PM | 1351 Ias01cActivity.htm |
| 7/30/2002 6:06 PM | 19694 Ias01cActivity.xsl |
| 8/23/2002 11:39 AM | 9863 IasQueryIdentity.htm |
| 8/23/2002 11:22 AM | 2931 IasQueryIdentity.xsl |

1. The audit reports directory 710 preferably lists the model Audit reports (and any that the user may have added). The file names tend to resemble the report title (e.g., IasActivitySumm.htm is the Activity Summary by Users report). For each report, there are two files concerned (HTM and XSL for Audit Reports, as described herein):

a. filename.htm—Contains the code for the query window that appears when the user selects the report from the Report type dropdown field.

b. filename.xsl—Style sheet that contains the code for the report output that appears when the user selects Generate in the Audit Reports window.

2. A user right clicks on the desired .htm file selects Save Target As . . . and provides a unique name for the user's new report. It is recommended that both files should have the same file name (i.e., the extension is different).

3. A user repeats the previous step for the corresponding .xsl file.

4. Using the user's editor of choice, a user formats the report file (.htm) and style sheet (.xsl) as necessary and copies the files back to the /AuditRpts directory.

### Uploading and Adding New Reports

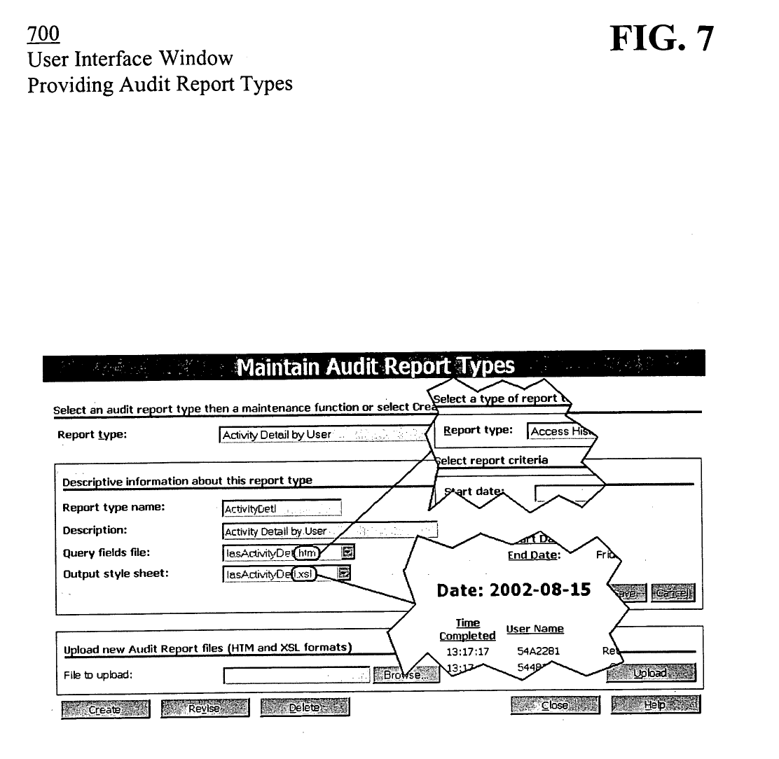

FIG. 7 illustrates a user interface window providing audit report types 700, in accordance with a preferred embodiment of the present invention. Once a user has created or 20 modified an Audit query field file and style sheet, a user needs to upload it to the AuditRpts directory. From the Administrator menu, select Audit Report Types to display the following window.

1. In the File to upload field towards the bottom of the screen, a user enters the .htm file name or use the Browse . button to locate it and clicks Upload.

2. A user repeats this step for the .xsl file.

Next a user needs to add this report to the Report type dropdown list.

1. A user clicks the Create button.

2. A user enters a Report type name and a Description (the Description is what will appear on the dropdown list).

3. A user selects the .htm file from the Query fields file field and the corresponding .xsl file from the Output style sheet dropdown list.

4. A user clicks the Save button.

### Security Concepts

Document imaging security permits a user to secure permission for the following system components: document imaging application, document types, folder types, and functions. Each separate, securable item is referred to as a token. Permissions for these items are granted to an NT Control Group, which is composed of Roles. A Role is a logical collection of application users who perform similar functions. Using Groups in Windows 2000 vs. NT 4.0

In Windows 2000, users have the flexibility of creating two types of groups:

1. Role Groups: Users are assigned to Role Groups.

2. Control Groups: Permissions are assigned to Control Groups.

This provides the flexibility of defining different roles in a user's organization (e.g., scanners, DI users, administrators, etc.) and assigning model permissions (i.e., the Control Group). A user could also create groups that have like users (i.e., Role Group). A user could then add multiple Role Groups to a Control Group. Note that, in reality, a user is nesting one or more group within another. For example, scan station users at the various registration areas (i.e., personnel who scan the same types of documents, like insurance cards, consents, etc.) into the same type of folders (e.g. patient encounter folders), and perform the same types of functions (e.g., scan documents, display documents). A recommended technique is to use the same name for both the Control Group and the Role Group, identifying the Role Group by adding the word “Role” at the end of the name. For example,

1. Control Group: DI Registration Scanners—Document Imaging IP and OP Reg Scanners (Note: This is where the permissions are granted.).

2. Role Group: DI Registration Scanners Role—Document Imaging IP and OP Users (Note: This is where the users are assigned.).

In NT 4.0, users do not have the ability to nest groups within groups.

### Both Permissions Tokens

A token is a single object representing something that is securable with the document imaging application. There are five categories of security tokens, as described in the following Table 8. Table 8 illustrates security tokens, in accordance with a preferred embodiment of the present invention.

TABLE 8
Security Tokens

| Type | Token Prefix | Example |
|---|---|---|
| Application | dddd | IMSAPP |
| Function | FN_{—} | FN_MAINT_FLDTYPES |
| | | (Maintain Folder Types) |
| Folder Type | FT_{—} | FT_MEDREC |
| | | (Medical Record |
| | | Folder) |
| Document Type | DT_{—} | DT_UB92 |
| Folder | VIP_{—} | VIP_CELEBRITY |

### Application Token

The document imaging application security token (IMSAPP) is preferably checked at the enterprise level. If a user does not have the EXECUTE permission for this token, then the user is not able to access the application.

### Function Tokens

The document imaging function tokens (e.g., FN_MAINT_DOCTYPES) are preferably checked at the enterprise level. The one exception is the FN_MAINT_OLCRPTUNDO token which can be applied at the organization level. If a user does not have the EXECUTE permission for a given function token, and the token has an associated menu item on the document imaging menu, then that menu item will not be visible. If a user doesn't have the EXECUTE permission for any menu items for a given menu (e.g., Administrator menu), then the entire menu is not visible.

### Folder Type Tokens

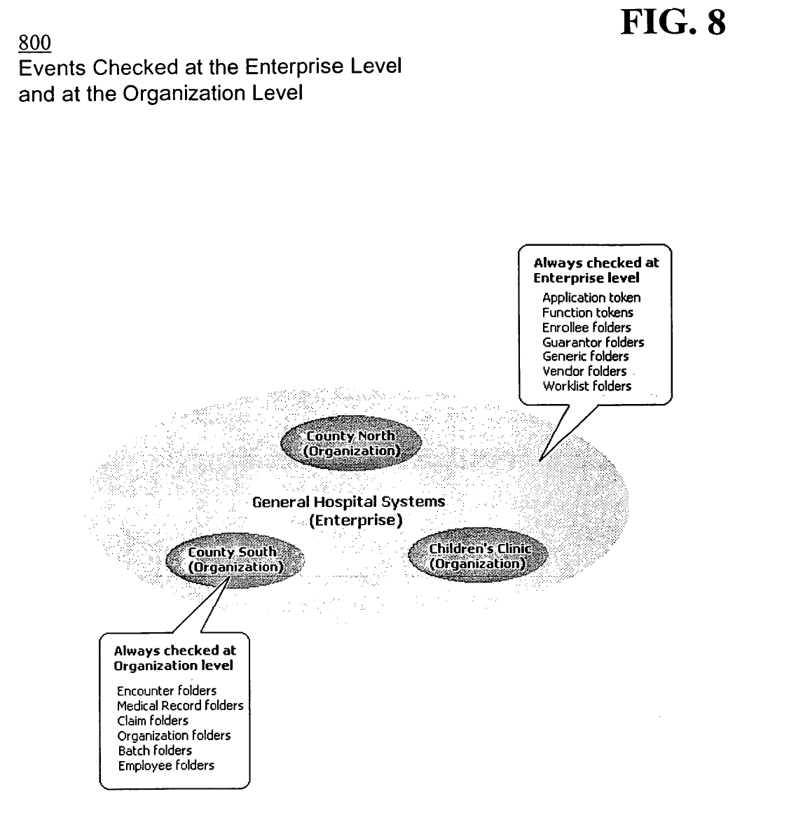

In general, for folder types except Organization, if a user assigns Create permission for that folder type, a user should provide Read permission. Folder-type security tokens apply to instances of folders, not to folder types themselves. In a multi-organization configuration, folder type security can be checked at either the enterprise level or organization level, depending upon the type of the folder in question, as further describe in FIG. 8.

The following folder types are checked at the Enterprise level:

1. Enrollee.

2. Guarantor.

3. Vendor.

4. Worklist.

5. Any Generic folder type.

The following folder types are checked at the Organization level:

1. Encounter.

2. Medical Record.

3. Claim.

4. Organization.

5. Batch.

6. Organization.

### Document Type Tokens

Document type security tokens apply to instances of documents, not to document types themselves. Document instances are preferably “owned” by or “belong” to the enterprise; however, in a multi-organization configuration, document type security can be checked at either the enterprise level or organization level depending upon the situation. Preferably, the document type security tokens would be checked at the enterprise level when:

1. Creating, revising, or deleting an instance of a document of a given type (foreground or background processing), or

2. Retrieving an instance of a document of a given type via the Retrieve Documents function

Preferably, the document type security tokens would be checked at the organizational level when:

1. Opening a folder (using the Display Folder function), which is directly tied to a given organization (e.g., an Encounter folder) that contains document of a secured document type.

### VIP Folder Instance Tokens

The VIP Item field provides an extra layer of security for folders by granting them VIP status. VIP security can be applied to any instance of a folder via the Create, Revise, Delete Folders function on the Folders and Documents menu. Preferably, users with EXECUTE permission for the FN_SECURE_FOLDER security token (i.e., Secure Folder Instance) can apply VIP security to a given folder instance; otherwise, the VIP item drop-down list is disabled.

When a user tries to access a folder, first a check is performed to see if a user has a given permission (e.g., READ, UPDATE or DELETE) for a given folder type. If the user has the permission, then a check is performed to see if the user has the permission for the VIP token (e.g., VIP_CELEBRITY) before the given operation can be performed.

Notes that:

1. For items that are checked at the organization level, it is assumed that the security for the individual hospitals is configured to work that way. By default when a user creates an organization using the Organization option on the Administrator menu, the “security used” field will default to the enterprise level security setting.

2. The users would also need READ, UPDATE or DELETE permissions for the appropriate VIP status (i.e., VIP_CELEBRITY, VIP_GOV_OFFICIAL, or VIP_HOSP_EMPLOYEES).

3. Although the VIP security layer was designed to safeguard patient-related information, it can be applied to any folder type in the system (i.e., generic.).

4. The VIP status can be assigned at the time the folder is created or it can be assigned anytime the folder is revised.

5. The EXECUTE permission on the FN_SECURE_FOLDER token allows a user to assign the VIP status. If this permission is not granted, the user will not be able to access the VIP Status field. If this permission is granted, READ, UPDATE or DELETE permissions for the given VIP token (e.g., VIP_CELEBRITY) will apply when a user attempts to retrieve, update, or delete the folder with a VIP status.

### Enterprise vs. Organization

FIG. 8 illustrates a healthcare enterprise 800 having events checked at the enterprise level and at the organization level, in accordance with a preferred embodiment of the present invention. Certain security tokens are checked at the enterprise level while others are checked at the hospital level. Any grants at the enterprise level flow down to the organization level (i.e., assumed grants at the organization level(s)). Any grant at the organization level overrides a deny at the enterprise level.

### Assign Tokens to Document Imaging

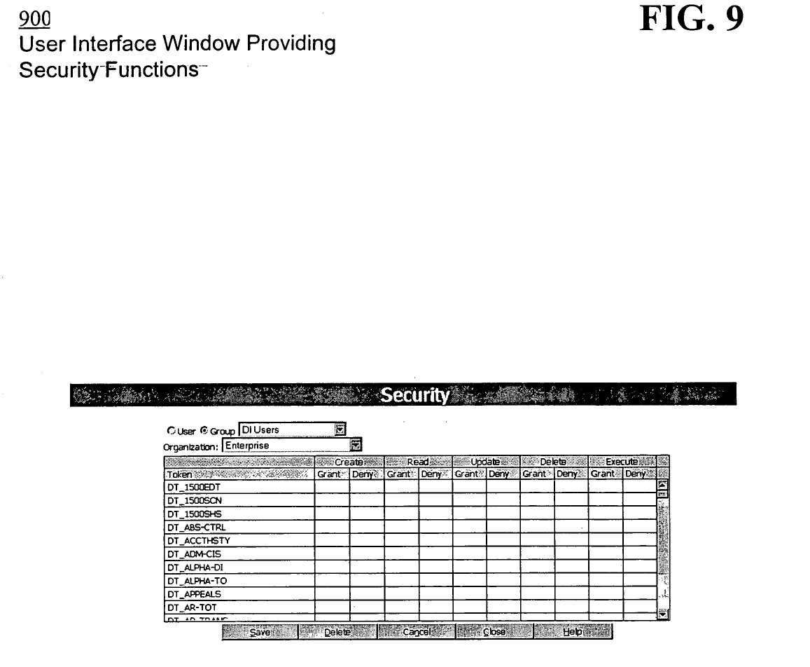

FIG. 9 illustrates a user interface window providing security functions 900, in accordance with a preferred embodiment of the present invention. The Security function enables a user to assign or deny access to the different functions and screens in the Imaging application. From the Administrator menu, a user selects “Security” to display the window 900. The Security may be applied to a user or a group for various enterprises. Security functions for each Security Token include, without limitation, Create, Read, Update, Delete, and Execute.

Preferably, in a healthcare enterprise, the user interface window providing security functions 900 provides access to a memory to provide a security information store identifying patient record access authorization information for personnel of different organizations, as shown in FIG. 9. Preferably, the Report Generation process 114 also provides an authorization processor for enabling access by an individual (e.g., user) of one of the organizations to a patient medical record in response to authorization determined from the patient record access authorization information. Hence, the security information store in combination with the authorization processor permit an organization to provide secure and protected access to the information.

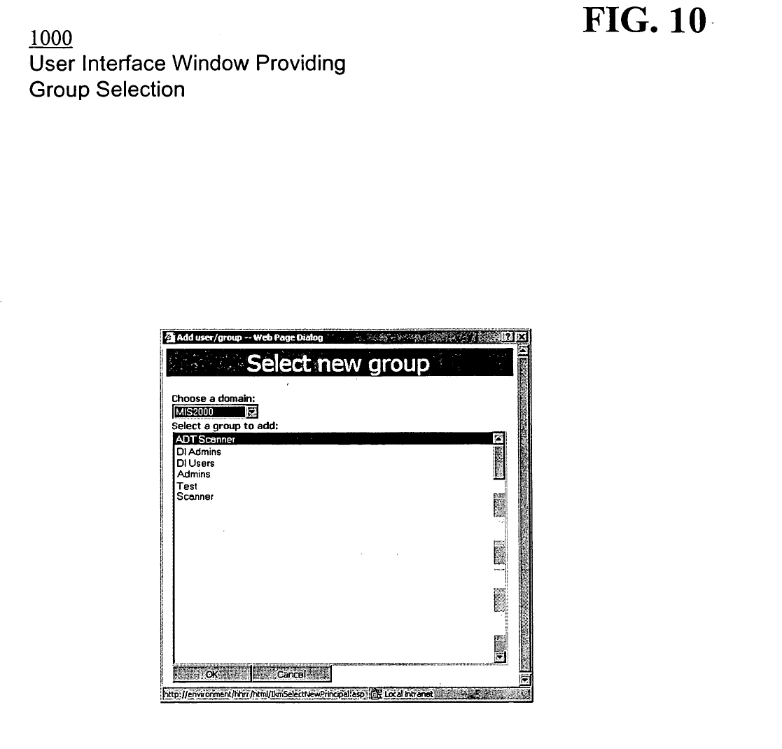

FIG. 10 illustrates a user interface window providing group selection 1000, in accordance with a preferred embodiment of the present invention. FIG. 10 generally describes a healthcare enterprise, such as a general hospital system, having a county north organization, a county south organization, and a children's clinic organization. Preferably, encounter folders, medical record folders, claim folders, organization folders, batch folders, and employee folders are always checked at the organization level. Preferably, the application token, the function tokens, the enrollee folders, the guarantor folders, the generic folders, the vendor folders, and the worklist folders are always checked at the enterprise level.

Preferably, before assigning security to groups, a user first defines groups and adds the groups to NT. Preferably, for each Group, a user performs the followings steps.

1. In FIG. 9, a user ensures the Group radio button is selected, then selects the group from the drop-down (if present), or selects Other group from the dropdown list next to Group button.

2. In FIG. 10, if necessary, a user selects the desired domain from the dropdown list then selects the desired group and clicks the OK button.

3. In FIG. 9, from the Organization menu, a user selects Enterprise.

4. In FIG. 9, a user assigns rights for the different functions, folder types, and document types.

5. In FIG. 9, a user clicks the Save button.

After the user performs these steps, the selected group automatically appears on the Group picklist.

### Organizations and Groups

If the user is in a single-site, single organization facility, a user leaves the Organization selection as Enterprise. Preferably, when the user creates a group and assign permissions to functions within the group, these permissions are effective across organizations within an enterprise. Thus, when the user assigns permissions to a Group, the user should first assign them across the Enterprise. By selecting a particular Organization, the only tokens the user is able to change are Folder and Document types.

In summary of the preferred embodiments of the present invention, the Audit Subsystem 100 provides a centralized mechanism to record and report on activity performed in any software application, whether initiated by automated processes or by user interaction. The Audit Subsystem 100 may be used by any information system. For the purposes of auditing, system activity is made up of independent events, each of which is tracked and audited in some way. Each event is a combination of an action and any data on which that action is performed. Actions may involve reading and/or manipulating data, reading and/or changing system configurations, or simply accessing the system as a whole. The Audit Subsystem 100 advantageously provides a central, software-driven mechanism that monitors and records the processed information automatically resulting in improved record keeping, management, security, and productivity for an information system.

Hence, while the present invention has been described with reference to various illustrative embodiments thereof, the present invention is not intended that the invention be limited to these specific embodiments. Those skilled in the art will recognize that variations, modifications, and combinations of the disclosed subject matter can be made without departing from the spirit and scope of the invention as set forth in the appended claims.

What is claimed is:

1. A system for monitoring activity of at least one executable application, comprising:
an input processor for receiving a message identifying an event representing activity performed by an executable application and containing data associated with said event, said event associated data including a start and stop time of said event;
an event processor for storing a record of said identified event and said event associated data in a record repository;
a monitoring processor for selecting particular events to use in monitoring a particular activity of said at least one executable application in response to a received command; and
an output processor for collating event associated data, retrieved from said record repository, for said selected particular events and for processing and formatting said collated event data for presentation to a user.

2. The system of claim 1, wherein
said record repository associates an event with at least one of, (a) an action type identifier, (b) an action identifier, (c) a category identifier and (d) a client or user associated identifier, said action being performed by said executable application.

3. The system of claim 1, wherein
said event associated data includes at least one of, (a) an application environment identifier, (b) a computer job identifier, (c) an identifier of an entity responsible for said event, (d) an identifier of a user responsible for said event, (e) an identifier of a type of client location requesting said event, (f) an identifier of a client location associated with requesting said event, (g) an indication of success or failure of said event, (h) an identifier of an object type acted upon in said event, (i) an identifier of a number of objects acted upon in said event and (j) an identifier of a datastream including data indicating objects acted upon in said event.

4. The system of claim 1, wherein
said monitoring processor selects particular events to use in monitoring a particular activity of said at least one executable application in response to received query criteria; and
said output processor processes and formats said collated event data for presentation to a user in at least one of, (a) a displayed image and (b) a report.

5. The system of claim 1, wherein
said monitoring processor intermittently and automatically selects particular events to use in monitoring a particular activity of said at least one executable application in response to predetermined schedule information; and
said output processor processes and formats said collated event data for presentation to a user in at least one of, (a) a displayed image and (b) a report, in response to predetermined schedule information.

6. The system of claim 4, wherein
said monitoring processor selects particular events to use in monitoring access to patient medical records in response to received query criteria.

7. A data access monitoring system for enabling access to patient medical record information by personnel of different organizations at different locations, comprising:
a security information store identifying patient record access authorization information for personnel of said different organizations;
an authorization processor for enabling access by an individual of one of said organizations to a patient medical record in response to authorization determined from said patient record access authorization information;
an input processor for receiving a message identifying an event associated with access by an individual of one of said organizations to a patient medical record and containing data associated with said event, said event associated data including a start and stop time of said event;
an event processor for storing a record of said identified event and said event associated data in a record repository; and
a monitoring processor for selecting particular events to use in monitoring access by said individual of one of said organizations to said patient medical record.

8. A system according to claim 7, including
an output processor for collating event associated data, retrieved from said record repository, for said selected particular events and for processing and formatting said collated event data for presentation to a user.

9. A system according to claim 7, wherein said multiple organizations includes one or more organization types selected from (a) a hospital, (b) a physician group, (c) clinic, (d) a healthcare payer institution, (e) a healthcare provider institution, and (f) a hospital department.

10. A data access management system for enabling access to patient medical record information by personnel of different organizations at different locations, comprising:
a security information store identifying patient record access authorization information for personnel of said different organizations;
an authorization processor for enabling access by an individual of one of said organizations to a patient medical record in response to authorization determined from said patient record access authorization information;
an input processor for receiving a message identifying an event associated with access by an individual of one of said organizations to a patient medical record and containing data associated with said event;
an event processor for storing a record of said identified event and said event associated data in a record repository; and
a monitoring processor for selecting particular events to use in monitoring access by said individual of one of said organizations to said patient medical record.

11. A system according to claim 10, wherein
said monitoring processor collates records of said selected particular events to provide an audit trail identifying for said individual of one of said organizations, (a) a user identifier, (b) an organization associated with said user, (c) a location of said organization associated with said user and (d) a patient record accessed.

12. A system according to claim 11, wherein
said monitoring processor collates records of said selected particular events to provide an audit trail identifying at least one of, (a) patient record alterations, (b) patient record deletions, (c) patient record additions and (d) start time and stop time of patient record access.

13. A system according to claim 10, wherein
said patient medical record includes, (a) patient clinical information, (b) patient billing or financial information, (c) medical referral information, (d) medical eligibility verification information, (e) medical necessity verification information and (f) medical procedure cost or reimbursement amount information.

14. A system according to claim 10, wherein
said input processor receives a message identifying an event associated with access by an individual of one of said organizations to patient medical record information comprising at least one of, (a) patient clinical information, (b) patient billing or financial information, (c) medical referral information, (d) medical eligibility verification information, (e) medical necessity verification information and (f) medical procedure cost or reimbursement amount information.

15. A system according to claim 10, wherein
said authorization processor enables access by an individual of one of said organizations to patient medical record comprising at least one of, (a) patient clinical information, (b) patient billing or financial information, (c) medical referral information, (d) medical eligibility verification information, (e) medical necessity verification information and (f) medical procedure cost or reimbursement amount information.
